(19) United States
(12) Patent Application Publication
(10) Pub. No.: US 2026/0204587 A1
(43) Pub. Date: Jul. 16, 2026

(54) CORROSION RESISTANT BATTERY CURRENT COLLECTOR

(71) Applicant: Medtronic, Inc., Minneapolis, MN (US)

(72) Inventors: Eric I. Hanson, Maple Grove, MN (US); Laura E. McCalla, Brossard (CA); Marissa A. Carey, St. Paul, MN (US)

(21) Appl. No.: 19/134,307

(22) PCT Filed: Nov. 8, 2023
(86) PCT No.: PCT/IB2023/061289

§ 371 Date: May 30, 2025

Related U.S. Application Data
(60) Provisional application No. 63/429,408, filed on Dec. 1, 2022.

(51) Int. Cl. H01M 4/66; H01M 10/0525; H01M 10/0568

(52) U.S. Cl. CPC H01M 4/667; H01M 10/0568; H01M 10/0525; H01M 2220/30

(57) ABSTRACT

Current collectors that include a bulk material defining a surface and a passivating region forming at least a portion of the surface. The bulk material includes a base metal and a dopant metal. Methods of forming current collectors. Batteries having a current collector disposed therein. Methods of using batteries having a current collector disposed therein.

This application claims the benefit of U.S. Provisional Patent Application Ser. No. 63/429,408, filed 1 Dec. 2022, the entire content of which is incorporated herein by reference.

### TECHNICAL FIELD

This disclosure generally relates to current collectors for batteries. More specifically, this disclosure relates to corrosion resistant current collectors.

### BACKGROUND

For many battery-powered medical tools and devices, the ability to be both cordless and rechargeable is beneficial. For high-powered, high-energy applications, the use of lithium ion battery technology is particularly well suited for battery-powered medical equipment, such as surgical tools. To be safely used in an operating room, the battery-powered surgical tool must be sterile. In some cases, the surgical tool is sterilized without the battery followed by aseptic transfer of the battery into the sterile tool. These aseptic transfer methods require several people and a sterile field that must not be broken. In a different method, the battery-powered surgical tool containing the battery is sterilized using hydrogen peroxide gas plasma at a low temperature (temperatures less than 50° C.). Although the battery-powered surgical tool can be sterilized with the battery already inserted, the hydrogen peroxide gas plasma method requires specialized equipment, such as a STERRAD instrument (available from Advanced Sterilization Products).

### SUMMARY

The techniques of this disclosure generally relate to batteries. The batteries include a current collector. In some embodiments, the current collector is corrosion resistant.

A first aspect of this disclosure relates to a current collector for a lithium ion battery. The current collector includes a bulk material that defines a surface. The bulk material includes a base metal doped with a metal dopant. In some embodiments, the base metal is doped with 0.01 wt-% to 49.9 wt-% of the dopant. In some embodiments, the dopant is magnesium. In some embodiments, the base metal is aluminum. The current collector also includes a passivating region that forms at least a portion of the surface. The passivating region includes a dopant-halide passivating group that includes at least a portion of the metal dopant. In some embodiments when the current collector is disposed within a battery, after at least one cycle that includes exposure to conditions of a temperature that is 100° C. or greater for 4 min or greater, the current collector retains at least 50% of its mass, the current collector retains at least 50% of its thickness, the battery retains at least 50% of its capacity, or combinations thereof, as compared to the current collector and/or battery prior to exposure to the at least one cycle.

A second aspect of this disclosure relates to a lithium-ion battery that includes a current collector of the present disclosure. The lithium-ion battery also includes a housing and an electrode assembly. The electrode assembly includes a positive electrode, a negative electrode, a separator, and an electrolyte. In some embodiments, the electrolyte includes a halogen containing salt. In some such embodiments, the halogen of the halogen containing salt is fluorine or chlorine.

A third aspect of this disclosure relates to a method of making a current collector of the present disclosure. The method includes contacting the bulk material with a passivation mixture. In some embodiments, the passivation mixture includes a halogen containing gas, a halogen containing salt, or both. In some embodiments, the method further includes, exposing the bulk material to a migration temperature to form a metal dopant gradient within base metal. In some embodiments, the method further includes forming the battery that includes the current collector and passivation mixture and allowing the passivation region to form in situ within the battery.

A fourth aspect of this disclosure relates to a method of using a battery that includes a current collector of the present disclosure. The method includes discharging the battery, charging the battery, and exposing the batter to a condition that includes a temperature of 100° C. or greater for at least one minute. In some embodiments, the steps of the method are repeated two to 500 times.

All scientific and technical terms have meanings commonly used in the art unless otherwise specified. The definitions provided are to facilitate understanding of certain terms used in the present disclosure.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

The term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range, including non-integers unless otherwise stated (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The terms “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The term “room temperature” or “ambient temperature” refers to a temperature of 20° C. to 25° C.

The term “in the range” or “within a range” (and similar statements) includes the endpoints of the stated range.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments unless explicitly stated otherwise.

The above summary of the present disclosure is not intended to describe each disclosed embodiment or every implementation of the present disclosure. The description that follows more particularly exemplifies illustrative embodiments. In several places throughout the disclosure, guidance is provided through lists of examples, which examples may be used in various combinations. In each instance, the recited list serves only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may be discussed herein, in no event should such discussions serve to limit the claimable subject matter.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a schematic cross sectional view of current collector consistent with embodiments of the present disclosure.

FIG. 2 is a schematic cross sectional view of second current collector consistent with embodiments of the present disclosure.

FIG. 3A is a schematic cross sectional view of a battery consistent with embodiments of the present disclosure.

FIG. 3B is a schematic of an electrode assembly consistent with embodiments of the present disclosure.

FIG. 4 is a flow diagram of a method of making the current collectors of the present disclosure.

FIG. 5 is a flow diagram of a method of using the batteries of the present disclosure.

### DETAILED DESCRIPTION

Batteries typically have an operating temperature range, and exposure to temperatures outside that range may result in mechanical and/or electrochemical degradation of the battery. For example, lithium ion batteries typically are configured to operate within the temperature range of −20° C. to 60° C. In some battery applications, it is desirable to temporarily subject a battery to a temperature outside of its temperature range. For example, it may be desirable to subject a lithium-ion battery powered medical equipment (e.g., medical device or tool) to temperatures greater than 60° C. to sterilize the equipment while the battery is operably coupled to the equipment. Many hospitals have autoclaves for sterilizing equipment. As such, it would be beneficial to make use of the autoclaves for sterilizing battery-powered surgical tools already having the battery disposed within. In order to achieve this goal, the lithium ion battery must withstand a standard steam autoclave cycle (e.g., 134° C. for 18 minutes) and maintain usability at application temperature (e.g., 10° C. to 45° C.) for 100 to 300 autoclave cycles. Thus, batteries, such as lithium ion batteries, are needed that can withstand high temperature conditions while maintaining their power output. Such batteries may be used in a variety of diagnostic tools, medical devices, and hand-held surgical tools that are commonly sterilized prior to use. Examples of such devices and tools include ultrasonic dissectors, vessel sealing devices, staplers, orthopedic saws and drills, radiofrequency powered surgical sealing devices, nerve integrity monitoring devices, ablation devices, powered atherectomy devices, pumps, implantable medical devices, wearable medical devices, and the like. In addition to medical equipment, batteries may be exposed to high temperatures in other applications. For example, batteries in equipment used for deep drilling operations may be exposed to temperatures up to 180° C. Besides special battery applications, consumer products having batteries may be intentionally or inadvertently exposed to high temperatures, for example, being left in a vehicle on a hot day. These exposures to extreme temperature may impact the performance of the battery.

Current collector corrosion in batteries may impact the performance of the battery. For example, corrosion of the current collector may lead to a loss in battery capacity and/or loss of the mechanical integrity of the current collector. When used in reference to a current collector, the term “corrosion” refers to the degradation of a current collector through the dissolution of the material making up the current collector resulting in reduction in the mass of the current collector. In reference to a battery, a current collector is an electrical bridge that allows for the transport of electrons to and from an external circuit (e.g., the device/tool to which the battery is operably coupled). As such, current collectors are made of conductive material, such as metals (e.g., aluminum, copper, titanium, and the like). Degradation of the current collector through corrosion results in a loss of conductive material mass which may impact battery performance. Corrosion may occur during battery manufacturing (e.g., the loading of cathode active material onto a current collector), during battery discharging, during battery charging, when the battery is electrochemically inactive, or combinations thereof. Corrosion may occur over the lifetime of a battery and ultimately manifest as pitting corrosion, crevice corrosion, stress corrosion cracking, and the like.

The mechanisms through which battery current collector corrosion occurs are complex and not entirely known. The mechanisms of corrosion depend on the current collector composition, electrolyte composition, operating voltage of the battery, temperatures to which the battery is exposed, manufacturing conditions, and the like. It is thought that current collector corrosion may be caused by reactions (e.g., electrochemical reactions) between the current collector and other battery components such as the electrolyte solvent, the electrolyte salts, the cathode active materials, degradation products thereof, ions thereof, radicals thereof, or combinations thereof. One proposed mechanism involves the attack of current collector material and/or oxidized current collector material by acidic species which promotes the corrosion of the current collector. Another proposed mechanism involves the electrochemical oxidation of electrolyte solvent molecules to form solvent radical cations. The radical cations can then undergo deprotonation to release protons which can then promote the dissolution of the material that makes up of the current collector. For example, in a lithium ion battery that includes an aluminum cathode current collector, oxidation of electrolyte solvent molecules may promote dissolution of A13+ and/or other aluminum containing compounds.

Current collectors may have an oxide and/or metal-halide passivation layer that prevents and/or reduces corrosion of the current collector. Passivation is the process by which a base metal (e.g., a metal) acquires a protective surface layer that prevents and/or reduces the base metals susceptibility to corrosion. A passivating layer may be formed through the chemical reaction of the base metal with a compound, an ion thereof, or a radical thereof, and/or through the spontaneous oxidation of the base metal in air. For example, aluminum, a common cathode current collector in lithium ion batteries, may have a passivating surface layer that includes Al₂O₃. Al₂O₃ is spontaneously formed on the surface of aluminum when exposed to oxygen.

In the context of a battery, a passivating salt may be included in the electrolyte of the battery. The passivating salt can participate in the formation of a current collector passivating layer. Specifically, passivating salts, decomposition products of the passivating salts, ions thereof, radicals thereof, or combinations thereof can participate in reactions with the current collector to form passivation groups. A plurality of passivation groups may form a passivating region and/or a passivating layer. The term “passivating salt” refers to a salt that can react with one or more materials of the current collector to form a reaction product that is a passivation group. It is understood that the term salt (e.g., a passivating salt) when used in the context of a reaction with a chemical species (e.g., a material of a current collector) includes the salt, decomposition products of the salt, ions thereof, radicals thereof, and combinations thereof.

In some batteries the electrolyte includes a halide containing salt that can react with the current collector material to form a current collector material-halide reaction product that acts as a passivation group. For example, in many lithium ion batteries, a large fraction of the salt included in an electrolyte is lithium hexafluorophosphate (LiPF₆), a salt know to suppress the corrosion of Al foil current collectors through the creation of a passivation layer. Generally, in such batteries, the LiPF₆ can react with the aluminum and/or the aluminum oxide of the current collector to ultimately form a passivation layer that includes a plurality of AlF₃ passivation groups. In such lithium ion batteries, it is thought that two passivation layers exist; i) the Al₂O₃ layer and ii) a AlF₃ containing layer. The AlF₃ containing layer is the outermost layer and as such, the formation of the AlF₃ containing layer includes the reaction products of the LiPF₆ salt with the Al₂O₃ layer.

The most commonly used passivating salt LiPF₆ is generally not thermally stable and therefore may not function in its passivating capacity when used in batteries that are exposed to high temperatures. For example, LiPF₆ degrades around 80° C. (e.g., to form insoluble LiF and PF₅ decomposition products as well as HF) which may prevent the formation of the passivation layer and/or increase the rate of current collector corrosion. As such, batteries that will be exposed to high temperatures are often manufactured with low (if any) LiPF₆. Without protection from a passivating salt, current collectors often have severe corrosion and performance loss. The use of other common halogen containing electrolyte salts in high temperature application lithium ion batteries may result in unstable current collectors. In some such batteries, a material-halide passivation layer (e.g., AlF₃) does not completely form leaving the current collector highly vulnerable to corrosion.

The present disclosure describes battery current collectors. In some embodiments, the current collectors of the present disclosure are corrosion resistant. In some embodiments, the current collectors of the present disclosure may be used in a primary battery, such as a lithium battery. Primary batteries are single use batteries that cannot be recharged. In some embodiments, the current collectors of the present disclosure may be used in a secondary battery, such as a lithium-ion battery. Secondary batteries are batteries that can be recharged and reused. In some embodiments, the current collector may be used as a cathode current collector. In other embodiments, the current collector may be used as an anode current collector. In some embodiments where the current collector is employed in a lithium ion battery, the current collector is the cathode current collector.

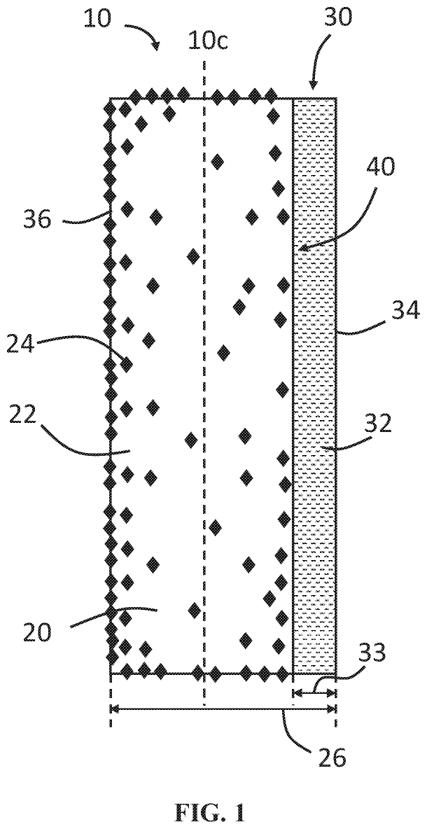

FIG. 1 is a cross sectional view of a schematic of a current collector consistent with embodiments of the present disclosure. The current collector 10 includes a bulk material 20 and a surface 34. The bulk material includes a base metal 22 doped with a metal dopant 24 and a passivating region 30. The passivating region 30 forms the surface 34 of the bulk material.

The bulk material 20 defines the configuration of the current collector. The current collector may be of any suitable configuration such as a foil, mesh (e.g., a knitted, woven, or expanded mesh), or a foam. FIG. 1 depicts a current collector 10 having a bulk material 20 with a foil configuration. A foil current collector has a sheet-like configuration and is often formed by rolling sheets of a metal into thinner sheets. In a mesh configuration, the bulk material is in a gride-like configuration that includes a plurality of transport pores that are randomly or evenly spaced. Transport pores are pores that have at least two pore openings and each pore opening is coupled to a surface exposing the pore to the surrounding environment. The mesh current collector may be made by weaving and/or knitting a plurality of wires together. In a foam, the bulk material is porous and includes transport pores and open pores. An open pore is a pore that has at least one pore opening that is coupled to a surface thereby exposing the pore to the surrounding environment. A foam configuration may be made for example, by the powder metallurgy foaming method, melt foaming method (e.g., direct blowing method or foaming agent foaming method), or the secondary foaming method.

The bulk material 20 defines at least one surface 34. When used in reference to the bulk material 20, a “surface” is a portion of the bulk material 20 that is directly exposed to the surrounding environment. The current collector configuration determines how many surfaces the bulk material has. For example, the current collector shown in FIG. 1 is a cross sectional view of a foil configuration in which the bulk material has a total of 6 surfaces (e.g., the facets of the foil) of which four are shown and one is labeled (e.g., surface 34). Other current collector configurations may have a different number of surfaces. Porous current collectors (e.g., a mesh or a foam), include a plurality of pores coupled to the surface, each pore having a pore surface. The pore surfaces are surfaces in that they are directly exposed to the surrounding environment. The surfaces of the bulk material 20 can have topography that is constant or that varies in the x, y, and/or z directions. For example, each one of the surfaces of the bulk material 20 can be smooth or rough. The bulk material 20 may have a single continuous surface, such as, for example, a spherical or ovoid configuration. The bulk material 20 may have multiple surfaces, for example, a polyhedron.

The bulk material 20 includes a base metal 22. The base metal 22 is the most abundant material of the bulk material 20 (e.g., greater than 50 wt-% of the bulk material). The base metal 22 may be any electrically conductive material (i.e., a material capable of conducting the flow of charge carriers such as electrons). The base metal 22 may be a metal such as transition metal (Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Dg, Bh, Hs) or a post-transition metal (Al, Ga, Zn, Cd, In, Sn, Hg, Ti, Pb, Bi, Po). In some embodiments, the base metal may be an alkali earth metal such as Mg. Specific examples of electrically conductive materials that are suitable for a current collector base metal 22 include copper (Cu), nickel (Ni), titanium (Ti), aluminum (Al), stainless steel, carbonaceous materials, and combinations thereof. In some embodiments, the base metal 22 is Al. In some embodiments, the base metal 22 is Ti. In some embodiments, the base metal 22 is Mg.

The base metal 22 is doped with a metal dopant 24. The metal dopant may be any metal (e.g., an alkaline earth metal (Be, Mg, Ca, Sr, Ba, Ra); a transition metal; or a post-transition metal (e.g., Al)). In some embodiments, the metal dopant 24 includes an alkaline earth metal. In some embodiments, the metal dopant 24 includes a post transition metal. The base metal 22 doped with the metal dopant 24 is an alloy. In some embodiments, the metal dopant 24 includes magnesium. In some embodiments, the metal dopant 24 includes aluminum. In some embodiments, the base metal 22 is aluminum, and the metal dopant 24 includes magnesium. In such embodiments, the current collector is an Al—Mg alloy. In some embodiments, the base metal 22 is magnesium, and the metal dopant 24 includes aluminum. In such embodiments, the current collector is an Al—Mg alloy.

The metal dopant 24 (e.g., magnesium or aluminum) may be present in the base metal 22 in any amount that does not destabilize the current collector. In some embodiments, the base metal includes 0.01 wt-% or greater, 0.05 wt-% or greater, 0.1 wt-% or greater, 0.5 wt-% or greater, 1 wt-% or greater, 2 wt-% or greater, 3 wt-% or greater, 4 wt-% or greater, 5 wt-% or greater, 10 wt-% or greater, 15 wt-% or greater, 20 wt-% or greater, 30 wt-% or greater, or 40 wt-% or greater of the metal dopant. In some embodiments, the base metal includes 49.9 wt-% or less, 40 wt-% or less, 30 wt-% or less, 20 wt-% or less, 15 wt-% or less, 10 wt-% or less, 5 wt-% or less, 4 wt-% or less, 3 wt-% or less, 2 wt-% or less, 1 wt-% or less, 0.5 wt-% or less, 0.1 wt-% or less, or 0.05 wt-% or less of the metal dopant. In some embodiments, the base metal includes 0.01 wt-% to 49.9 wt-%, 0.01 wt-% to 40 wt-%, 0.01 wt-% to 30 wt-%. 0.01 wt-% to 20 wt-%, 0.01 wt-% to 15 wt-%, 0.01 wt-% to 10 wt-%, 0.01 wt-% to 5 wt-%, 0.01 wt-% to 4 wt-%, 0.01 wt-% to 3 wt-%, 0.01 wt-% to 2 wt-%, 0.01 wt-% to 1 wt-%, 0.01 wt-% to 0.5 wt-%, 0.01 wt-% to 0.1 wt-%, or 0.01 wt-% to 0.05 wt-% of the metal dopant. In some embodiments, the base metal includes 0.05 wt-% to 49.9 wt-%, 0.05 wt-% to 40 wt-%, 0.05 wt-% to 30 wt-%. 0.05 wt-% to 20 wt-%, 0.05 wt-% to 15 wt-%, 0.05 wt-% to 10 wt-%, 0.05 wt-% to 5 wt-%, 0.05 wt-% to 4 wt-%, 0.05 wt-% to 3 wt-%, 0.05 wt-% to 2 wt-%, 0.05 wt-% to 1 wt-%, 0.05 wt-% to 0.5 wt-%, or 0.05 wt-% to 0.1 wt-% of the metal dopant. In some embodiments, the base metal includes 0.1 wt-% to 49.9 wt-%, 0.1 wt-% to 40 wt-%, 0.1 wt-% to 30 wt-%. 0.1 wt-% to 20 wt-%, 0.1 wt-% to 15 wt-%, 0.1 wt-% to 10 wt-%, 0.1 wt-% to 5 wt-%, 0.1 wt-% to 4 wt-%, 0.1 wt-% to 3 wt-%, 0.1 wt-% to 2 wt-%, 0.1 wt-% to 1 wt-%, or 0.1 wt-% to 0.5 wt-% of the metal dopant. In some embodiments, the base metal includes 0.5 wt-% to 49.9 wt-%, 0.5 wt-% to 40 wt-%, 0.5 wt-% to 30 wt-%, 0.5 wt-% to 20 wt-%, 0.5 wt-% to 15 wt-%, 0.5 wt-% to 10 wt-%, 0.5 wt-% to 5 wt-%, 0.5 wt-% to 4 wt-%, 0.5 wt-% to 3 wt-%, 0.5 wt-% to 2 wt-%, or 0.5 wt-% to 1 wt-% of the metal dopant. In some embodiments, the base metal includes 1 wt-% to 49.9 wt-%, 1 wt-% to 40 wt-%, 1 wt-% to 30 wt-%, 1 wt-% to 20 wt-%, 1 wt-% to 15 wt-%, 1 wt-% to 10 wt-%, 1 wt-% to 5 wt-%, 1 wt-% to 4 wt-%, 1 wt-% to 3 wt-%, or 1 wt-% to 2 wt-% of the metal dopant. In some embodiments, the base metal includes 2 wt-% to 49.9 wt-%, 2 wt-% to 40 wt-%, 2 wt-% to 30 wt-%, 2 wt-% to 20 wt-%, 2 wt-% to 15 wt-%, 2 wt-% to 10 wt-%, 2 wt-% to 5 wt-%, 2 wt-% to 4 wt-%, or 2 wt-% to 3 wt-% of the metal dopant. In some embodiments, the base metal includes 3 wt-% to 49.9 wt-%, 3 wt-% to 40 wt-%, 3 wt-% to 30 wt-%, 3 wt-% to 20 wt-%, 3 wt-% to 15 wt-%, 3 wt-% to 10 wt-%, 3 wt-% to 5 wt-%, or 3 wt-% to 4 wt-% of the metal dopant. In some embodiments, the base metal includes 4 wt-% to 49.9 wt-%, 4 wt-% to 40 wt-%, 4 wt-% to 30 wt-%, 4 wt-% to 20 wt-%, 4 wt-% to 15 wt-%, 4 wt-% to 10 wt-%, or 4 wt-% to 5 wt-% of the metal dopant. In some embodiments, the base metal includes 5 wt-% to 49.9 wt-%, 5 wt-% to 40 wt-%, 5 wt-% to 30 wt-%, 5 wt-% to 20 wt-%, 5 wt-% to 15 wt-%, or 5 wt-% to 10 wt-% of the metal dopant. In some embodiments, the base metal includes 10 wt-% to 49.9 wt-%, 10 wt-% to 40 wt-%, 10 wt-% to 30 wt-%, 10 wt-% to 20 wt-%, or 10 wt-% to 15 wt-% of the metal dopant. In some embodiments, the base metal includes 15 wt-% to 49.9 wt-%, 15 wt-% to 40 wt-%, 15 wt-% to 30 wt-%, or 15 wt-% to 20 wt-% of the metal dopant. In some embodiments, the base metal includes 20 wt-% to 49.9 wt-%, 20 wt-% to 40 wt-%, or 20 wt-% to 30 wt-% of the metal dopant. In some embodiments, the base metal includes 30 wt-% to 49.9 wt-% or 30 wt-% to 40 wt-% of the metal dopant. In some embodiments, the base metal includes 40 wt-% to 49.9 wt-% of the metal dopant.

The amount of dopant in the base metal may be determined using a variety of elemental analysis techniques. Example elemental analysis techniques include energy dispersive X-ray (EDX) composition analysis, inductively couples plasma mass spectrometry (ICP-MS), and electron energy loss spectroscopy (EEL).

In some embodiments, the base metal 22 includes a gradient of the metal dopant. A gradient is a concentration change over distance. The concentration is the highest at and proximate to the surfaces of the bulk material and decreases as the distance from a surface increases. For example, the metal dopant 24 of FIG. 1 material is at a higher concentration at and proximate to the surfaces (e.g., 36 and 34; the passivating region 32 includes a high concentration of the metal dopant) of the current collector 10. As the distance from the surfaces increase, the concentration of the metal dopant 24 decreases. The concentration of the metal dopant is the lowest proximate to the center (denoted as a center axis 10c) of the bulk material. The concentration gradient may be linear, exponential, parabolic, or any other mathematical function. Within the concentration gradient, there may be localized areas of higher or lower density of the metal dopant. The concentration gradient can be measured using an elemental analysis technique (e.g., EDX, ICP-MS, or EEL) coupled with ion milling.

In some embodiments, the metal dopant gradient spontaneously forms. For example, in some embodiments, the metal dopant gradient forms during the use of a battery that includes the current collector. In some such embodiments, throughout the use of the battery that includes the current collector, the current collector is exposed to an elevated temperature and/or a potential that accelerates gradient formation. Exposing the bulk material to an elevated temperature may allow for the metal dopant to migrate towards the surfaces of the bulk material. High concentrations of the metal dopant may be at or proximate to the surfaces of the bulk material which may allow it to participate in passivation reactions to from passivation groups.

The bulk material 20 of the current collector 10 includes at least one passivation region 30 that forms at least a portion of one surface 34 (or a portion of a surface) of the bulk material 20. The passivation region functions to prevent and/or decrease the likelihood of current collector corrosion (e.g., corrosion of the bulk material). The bulk material may include multiple passivation regions that form multiple surfaces. The bulk material may include a passivation region or multiple passivation regions that define a portion or portions of a surface. The passivation region 30 forms from the reaction of the base metal (e.g., the base metal and/or the metal dopant) with various chemical species. As such the passivation region forms an interface 40 with the base metal 22. The passivation region extends from the interface 40 to the surface 32 of which it forms.

The passivation region 30 includes at least one passivation group. In some embodiments, the passivation region 30 includes a plurality of passivation groups. Each passivation group is the reaction product of a component of a current collector with a component of the surrounding environment. Such reactions may be termed passivation reactions. When used in the context of a passivation reaction, the terms “base metal” and “dopant metal” are understood to include the base metal, the dopant metal, oxides thereof, hydroxides thereof, other metal-compound species (i.e., base metal-compound species and dopant metal-compound species), and combinations thereof. For example, a passivation group may be the passivation reaction product formed between the base metal or the dopant metal and a salt, oxygen, or both. Passivation groups may also be formed as the reaction product of an already formed passivation group with a chemical species in the surrounding environment. In some embodiments, the passivating region may include a plurality of passivation groups that include metal dopant-halide passivation groups, base metal-halide passivation groups, metal dopant-oxide passivation groups, base metal-oxide passivation groups, or combinations thereof.

The passivation region 30 includes the metal dopant. In some embodiments, the passivation region has a high concentration of the metal dopant. In some embodiments, the passivation region includes a higher proportion of passivation groups that include the metal dopant than passivation groups that include the base metal (if any).

At least one passivation group in the passivation region includes a metal dopant-halide passivation group. In some embodiments, the plurality of passivation groups in the passivating region 30 includes metal dopant-halide passivation groups. The metal dopant-halide passivation groups include at least a portion of the metal dopant. For example, in embodiments where the metal dopant or the base metal is magnesium, at least a portion of the passivation groups are magnesium-halides. The halide may be any halogen. In some embodiments, the halogen is fluorine. In other embodiments, the halogen is chlorine. In embodiments where the metal dopant includes magnesium, the metal-halide may be magnesium fluoride (MgF₂). In embodiments where the metal dopant includes magnesium, the metal-halide may be magnesium chloride (MgCl₂).

The metal dopant-halide passivation groups may be formed as the passivation reaction product between the metal dopant (e.g., the metal dopant or an oxide of the metal dopant) with a halogen of a halogen containing compound. The halogen or halogen containing compound may be in the form of a halogen containing salt within a mixture, a solution that includes a halogen acid (e.g., HCl, HF, HBr, HI), or a gas that contains a halogen (e.g., HCl, HF, F₂, Cl₂). The halogen containing salt, the halogen acid, and/or the halogen containing gas provides the halide of the metal-halide passivation group. For example, in embodiments where the passivating region includes MgF₂ passivation groups, the MgF₂ passivation groups may have been formed through the reaction of magnesium and/or magnesium oxide (MgO) with a fluorine containing salt. Examples of fluorine containing salts that may be used to form a metal-halide passivation group include lithium bis(trifluoromethanesulfonimide) (LiTFSI); lithium difluoro (oxalato)borate (LiDFOB); lithium bis(pentafluoroethyl sulfonyl)imide (LiBETI); lithium bis(fluorosulfonyl)imide (LiFSI), lithium difluoro (oxalate)borate (LiDFOB); lithium tetrafluoroborate (LiBF₄); bis(perfluoroethanesulfonyl)imide (LiPFSI or LiBETI); lithium-cyclo-difluoromethane-1,1-bis(sulfonyl)imide (LiDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dicyano-pentafluoroethyl-imidazole; and combinations thereof. In other embodiments where the passivating region includes MgCl₂ passivation groups, the MgCl₂ passivation groups may have been formed through the reaction of magnesium and/or magnesium oxide (MgO) with a chlorine containing salt. An example of a chlorine containing salt that may be used to form a metal-halide passivation group is lithium perchlorate.

The passivating region may include base metal-halide passivation groups. The base metal-halide passivation groups include at least a portion of the base metal. The plurality of base metal-halide passivation groups may include any halide and may be formed in any matter as discussed relative to the dopant metal-halides. In embodiments where the base metal is aluminum and the halogen is fluorine, the base metal-halide passivation groups may be aluminum trifluoride (AlF₃). In embodiments where the base metal is aluminum and the halogen is chlorine, the base metal-halide passivation groups may be aluminum trichloride (AlCl₃).

The passivating region may include dopant metal-oxide passivation groups. The dopant metal-oxide passivation groups include at least a portion of the metal dopant. Metal dopant-oxide passivation groups may be formed as the passivation reaction product between the metal dopant and chemical species that include oxygen or O₂. In embodiments where the metal dopant material is magnesium, the metal dopant-oxide passivation groups may be magnesium oxide (MgO).

The passivating region may include a base metal-oxide passivation group. The base metal-oxides include at least a portion of the base metal. Base metal-oxide passivation groups may be formed as the passivation reaction product between the base metal and chemical species that include oxygen or O₂. In embodiments where the base metal is aluminum, the base metal-oxide passivation groups may be aluminum oxide (Al₂O₃).

The metal dopant may be chosen such as to have a higher predicted reactivity in a passivation reaction than the base metal. The metal dopant may be chosen such as to have a lower predicted reactivity in a passivation reaction than the base metal. Not wishing to be bound by theory, it is thought that the reactivity of the dopant metal and/or base metal may allow for salts that are not normally passivating salts to be passivating salts and/or increase the ability of some salts to be passivating salts. In embodiments where the metal dopant is predicted to have a higher reactivity in a passivation reaction than the base metal, such salts may preferentially react in a passivation reaction with the dopant material to form passivation groups. In embodiments where the base metal is predicted to have a higher reactivity in a passivation reaction than the dopant metal, such salts may preferentially react in a passivation reaction with the base metal to form passivation groups. The metal dopant and/or base metal may allow for traditional lithium-ion battery electrolyte salts that have a higher thermal stability than LiPF₆ to be used as passivating salts.

In some embodiments, the passivation region may include passivation groups that are the reaction product of a non-halogen containing salt and the base metal and/or metal dopant. In some such embodiments, the passivation groups may be the reaction product between the base metal and/or dopant metal with a boron containing salt. Examples of such salts include lithium bis(oxalate)borate (LiBOB); lithium tetracyanoborates (Bison); and lithium dicyanotriazlate (DCTA).

In some embodiments, a salt is used is a halogen containing salt and boron contain salt such as difluoro-(oxalate)borate (LiDFOB). In such embodiments, passivation groups may from that are the reaction product between the base metal and/or dopant metal with the fluorine and/or the boron of LiDFOB.

In some embodiments, the passivating region 30 may form a continuous layer such as shown in FIG. 1. In such embodiments, the passivation region forms an entire surface of the bulk material. In other embodiments, the passivating region 30 may be discontinuous (i.e., the bulk material includes two or more passivating regions). In such embodiments, the passivation region forms a portion of a surface of the bulk material. In some embodiments, the passivating region 30 may be discontinuous at one point in time but form a continuous layer over at least a portion of the lifetime of the current collector.

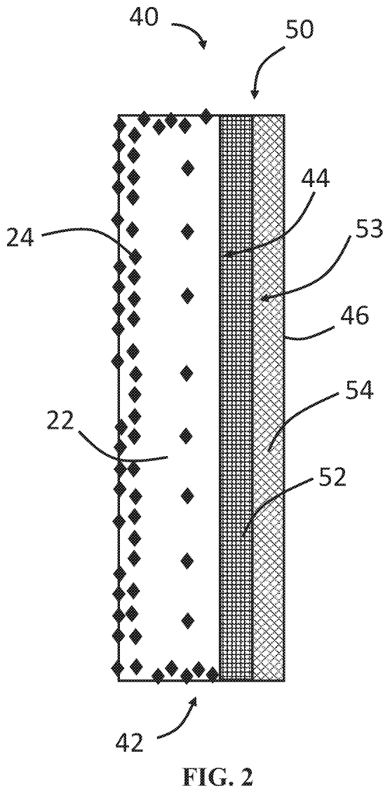

In some embodiments, the passivating region may include a multi-layer structure with two or more layers. FIG. 2 shows a cross sectional view of a current collector 40 consistent with embodiments of the present disclosure that includes a passivating region 50 that includes a first passivating layer 52 and a second passivating layer 54. The components of the current collector of FIG. 2 may have any configuration and/or property as described herein. The current collector 40 includes a bulk material 42 that defines at least one surface 46. The bulk material includes a base metal 22 that is doped with a metal dopant 24. The bulk material also includes a passivating region 50. The passivating region includes a plurality of passivation groups that include metal dopant-halide passivation groups.

The passivating region 41 includes a first passivating layer 52 and a second passivating layer 54. The first passivating layer 52 forms from the reaction of the base metal and/or the metal dopant with various chemical species to form a plurality of first passivation groups. As such, the first passivating layer 54 forms a first interface 44 with the base metal. The second passivating layer 54 forms from the reaction of at least a portion of the first passivation groups to form a plurality of second passivation groups. As such, the second passivating layer 54 forms a second interface 53 with the first passivating layer. The second passivating layer forms the surface 46 of the bulk material 42. The first passivating layer extends from the first interface 44 to the second interface 53. The second passivating layer extends from the second interface 53 to the surface 46. The first plurality of passivation groups and the second plurality of passivation groups may include any passivation group or combination of passivation groups as disclosed herein. In some embodiments, the first plurality of passivation groups includes a base metal-oxide (e.g., Al₂O₃), a metal dopant-oxide (e.g., MgO), or both. In some embodiments, the second plurality of passivation groups includes a base metal-halide (e.g., AlF₃), a metal dopant-halide (e.g., MgF₂), or both.

Returning to FIG. 1, the bulk material 20 has a thickness 26. The thickness is the average width of the bulk material (e.g., a foil) in its narrowest dimension. In some embodiments, the thickness may be 5 μm or greater, 10 μm or greater, 12 μm or greater, 14 μm or greater, 16 μm or greater, 18 μm or greater 20 μm or greater, or 25 μm or greater. In some embodiments, the thickness may be 30 μm or less, 25 μm or less, 20 μm or less, 18 μm or less, 16 μm or less, 14 μm or less, 12 μm or less, 10 μm or less, or 5 μm or less. In some embodiments, the thickness may be 1 μm to 30 μm, 5 μm to 20 μm, or 10 μm to 20 μm.

The passivating region 30 has a thickness 33. The thickness of the passivating region is the average width of the passivating region. In embodiments where the base metal includes two or more passivating regions, each passivating region has a thickness 33. In some embodiments the thickness of the passivating region may be one atomic layer or greater, 1 nm or greater, 2 nm or greater, 4 nm or greater, 6 nm or greater, 8 nm or greater, 10 nm or greater, or 15 nm or greater, 50 nm or greater, 100 nm or greater, or 250 nm or greater. In some embodiments the thickness of the passivating region may be 500 nm or less, 250 nm or less, 100 nm or less, 50 nm or less 20 nm or less, 15 nm or less, 10 nm or less, 8 nm or less, 6 nm or less, 4 nm or less, or 2 nm or less. In some embodiments the thickness of the passivating region may be 1 nm to 500 nm, 1 nm to 250 nm, 1 nm to 100 nm, 1 nm to 50 nm, 1 nm to 20 nm, 1 nm to 15 nm, 1 nm to 10 nm, 1 nm to 8 nm, 1 nm to 6 nm, 1 nm to 4 nm, or 1 nm to 2 nm. In some embodiments the thickness of the passivating region may be 2 nm to 500 nm, 2 nm to 250 nm, 2 nm to 100 nm, 2 nm to 50 nm, 2 nm to 20 nm, 2 to 15 nm, 2 nm to 10 nm, 2 nm to 8 nm, 2 nm to 6 nm, or 2 nm to 4 nm. In some embodiments the thickness of the passivating region may be 4 nm to 500 nm, 4 nm to 250 nm, 4 nm to 100 nm, 4 nm to 50 nm, 4 nm to 20 nm, 4 to 15 nm, 4 nm to 10 nm, 4 nm to 8 nm, or 4 nm to 6 nm. In some embodiments the thickness of the passivating region may be 6 nm to 500 nm, 6 nm to 250 nm, 6 nm to 100 nm, 6 nm to 50 nm, 6 nm to 20 nm, 6 to 15 nm, 6 nm to 10 nm, or 6 nm to 8 nm. In some embodiments the thickness of the passivating region may be 8 nm to 500 nm, 8 nm to 250 nm, 8 nm to 100 nm, 8 nm to 50 nm, 8 nm to 20 nm, 8 to 15 nm, or 8 nm to 10 nm. In some embodiments the thickness of the passivating region may be 10 nm to 500 nm, 10 nm to 250 nm, 10 nm to 100 nm, 10 nm to 50 nm, 10 nm to 20 nm or 10 to 15 nm. In some embodiments the thickness of the passivating region may be 15 nm to 500 nm, 15 nm to 250 nm, 50 nm to 100 nm, 15 nm to 20 nm. In some embodiments the thickness of the passivating region may be 50 nm to 500 nm, 100 nm to 500 nm, or 250 nm to 500 nm. The thickness of the passivation layer may be measured, for example, by taking a cross section of the current collector and using transmission electron microscopy (TEM) to measure the width of the passivating region.

In some embodiments, at least a portion of the current collector is surface treated (e.g., coated). In some embodiments, the current collector surface treatment includes a carbonaceous compound. Examples of carbonaceous compound current collector surface treatments include natural graphite, artificial graphite (e.g., mesocarbon microbead), and carbon black. In some embodiments, the current collector surface treatment includes a nano-scale carbon compound. Examples of nano-scale carbon compounds suitable for cathode current collector surface treatments include graphene, carbon nanotubes, and other carbon nano-scale coating such as those disclosed in U.S. Pat. No. 9,172,085. The use of nano-scale carbon surface treatments may allow for the use of less surface treatment material than non-nano-scale carbon surface treatments due to the larger surface area of the nano-scale carbon material.

In certain embodiments, at least a portion of the cathode current collector is surface treated with a positive temperature coefficient material. In some such embodiments, the positive temperature coefficient material is designed to raise the cell impedance at temperatures above 135° C.

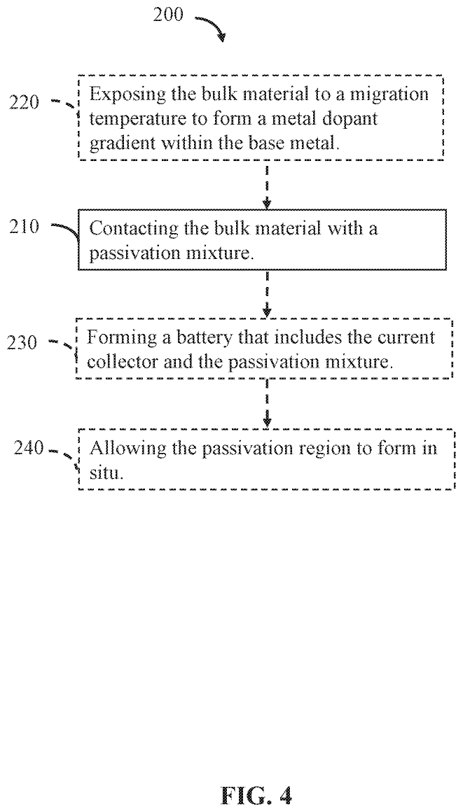

The present disclosure describes methods of making the current collectors of the present disclosure. A flow diagram of an example method 200 is shown in FIG. 4. The method 200 includes contacting the bulk material with a passivation mixture such that a passivation region is formed (step 210). The passivation mixture includes a halogen or a halogen containing compound. In some embodiments, the passivation mixture includes a halogen containing salt and/or an acid halogen and a liquid carrier. In other embodiments, the passivation mixture includes a halogen containing compound or a halogen in the gas and/or aerosolized phase. The halogen containing salt and the halogen acid may be any as described herein. The liquid carrier may be any suitable carrier such as water and/or any organic solvent or combination of organic solvents as described elsewhere herein.

Contacting the bulk material with the passivation mixture may be accomplished in any suitable method. In some embodiments, the bulk material is submerged into a passivation mixture. In other embodiments, the passivation mixture is sprayed or otherwise deposited onto the bulk mixture. In embodiments, the bulk material is exposed to the passivation mixture that is in the gas or aerosolized phase.

In some embodiments, contacting the bulk material with the passivation mixture may be done at a passivation temperature. The elevated temperature may facilitate and/or increase the rate of the passivation reactions. In some such embodiments where the passivation mixture includes a liquid carrier, the mixture may be preheated to a temperature and then contacted with the bulk material. In other such embodiments, the mixture may be contacted with the bulk material and then the whole system exposed to an elevated temperature. In yet other embodiments, the mixture may be preheated to a temperature and then contacted with the bulk material and the whole system may be exposed to an elevated temperature.

In some embodiments, the passivation temperature may be 50° C. or greater, 70° C. or greater, 90° C. or greater, 100° C. or greater, 120° C. or greater, 140° C. or greater, or 160° C. or greater. In some embodiments, the passivation temperature may be 200° C. or les, 160° C. or less, 140° C. or less, 120° C. or less, 100° C. or less, 90° C. or less, or 70° C. or less. In some embodiments, the passivation temperature may be 50° C. to 200° C., 50° C. to 160° C., 50° C. to 140° C., 50° C. to 120° C., 50° C. to 100° C., 50° C. to 90° C., or 50° C. to 70° C. In some embodiments, the passivation temperature may be 70° C. to 200° C., 70° C. to 160° C., 70° C. to 140° C., 70° C. to 120° C., 70° C. to 100° C., or 70° C. In some embodiments, the passivation temperature may be 90° C. to 200° C., 90° C. to 160° C., 90° C. to 140° C., 90° C. to 120° C., or 90° C. to 100° C. In some embodiments, the passivation temperature may be 100° C. to 200° C., 100° C. to 160° C., 100° C. to 140° C., or 100° C. to 120° C. In some embodiments, the passivation temperature may be 120° C. to 200° C., 120° C. to 160° C., or 120° C. to 140° C. In some embodiments, the passivation temperature may be 140° C. to 200° C. or 140° C. to 160° C. In some embodiments, the passivation temperature may be 160° C. to 200° C.

The total time the bulk material is in contact with the passivation mixture at the passivation temperature is the passivation time. In some embodiments, the passivation time is 1 min or more, 5 min or more, 10 min or more, 30 min or more, 1 hour or more, or 5 hours or more. In some embodiments, the passivation time is 24 hours or less, 5 hours or less, 1 hour or less, 30 min or less, 10 min or less, or 5 min or less. In some embodiments, the passivation time is 1 min to 24 hours, 1 min to 10 hours, 1 min to 5 hours, 1 min to 30 min, 1 min to 10 min, or 1 min to 5 min. In some embodiments, the passivation time is 5 min to 24 hours, 5 min to 10 hours, 5 min to 5 hours, 5 min to 30 min, or 5 min to 10 min. In some embodiments, the passivation time is 10 min to 24 hours, 10 min to 10 hours, 10 min to 5 hours, 10 in to 1 hour, or 10 min to 30 min. In some embodiments, the passivation time is 30 min to 24 hours, 30 min to 10 hours, or 30 min to 5 hours, or 30 min to 1 hour. In some embodiments, the passivation time is 1 hour to 24 hours, 1 hour to 10 hours, or 1 hour to 5 hours. In some embodiments, the passivation time is 5 hours to 24 hours or 5 hours to 10 hours. In some embodiments, the passivation time is 10 hours to 24 hours.

In some embodiments, the method 200 further includes exposing a pre-bulk material to a migration temperature to form a bulk metal comprising a metal dopant gradient within the base metal (step 220). The migration temperature may be any temperature that allows for the metal dopant to migrate from the center of the bulk material towards a surface. Allowing the metal dopant to migrate towards the surface and in some cases be exposed at a surface may allow for the metal dopant to participate (or preferentially participate) in passivation reactions.

In some embodiments, the migration temperature is room temperature (i.e., 20° C. to 25° C.) or greater, 30° C. or greater, 40° C. or greater, 50° C. or greater, 60° C. or greater, 80° C. or greater, or 90° C. or greater. In some embodiments, the migration temperature is 100° C. or less, 90° C. or less, 80° C. or less, 70° C. or less, 60° C. or less, 50° C. or less, 40° C. or less, or 30° C. or less.

In some embodiments, the passivation region may be formed while the current collector is disposed within a battery. In such embodiments, the method 200 further includes forming a battery that includes a current collector of the present disclosure (step 230). Descriptions of suitable battery and battery components are described elsewhere herein. In such embodiments, the method 200 further includes allowing the passivation region to from in situ within the confines of the battery (step 240). The passivation region may form throughout the lifetime of the battery as the current collector is in contact with an electrolyte that includes a halogen containing salt (see examples of such salts elsewhere herein). Exposure of the battery to elevated temperatures and/or potentials may increase facilitate and/or increase the in situ rate of formation of a passivation region.

In some embodiments, when employed in a battery that is subjected to elevated temperatures, the current collectors of the present disclosure are corrosion resistant. The amount of current collector corrosion can directly be ascertained through measuring the thickness and/or the mass of an unused current collector and its used current collector counterpart. Additionally, visual observations made with an unaided eye can be used to characterize current collector corrosion. For example, a current collector that is correct may result in the active material (anode active material or cathode active material) flaking off the current collector. An unused current collector is a current collector that has not yet been inserted into a battery. A used current collector is a current collector that has been used in a battery that has been subjected to a given set of conditions. It is understood that the term “unused counterpart” refers to a used current collector in its unused state. It is understood that the term “used counterpart” refers to an unused current collector in its used state.

The amount of current collector corrosion can be measured indirectly as the change in capacity of the battery in which the current collector is used. The change in capacity of the battery is the difference in the capacity of the battery prior to exposure to a given set of conditions and the capacity of the battery after exposure to the given set of conditions.

In some embodiments, the batteries (that include a current collector of the present discourse) of the present disclosure retain at least a major portion of their capacity as compared to the same battery prior to any exposure to an elevated temperature after repeated cycles. For the sake of clarity of the present disclosure, the term “cycle” refers to combination of one electrochemical cycle and one thermal cycle. In practice, the battery (with the current collector included within the battery) may be subjected to multiple electrochemical cycles prior to a single thermal cycle and vice versa. An electrochemical cycle includes discharging the battery to first state of charge (SOC) and charging the same battery to a second SOC. An electrochemical cycle may include charging the battery to an SOC of 50% or greater, 75% or greater, 80% or greater, 90% or greater, or 95% or greater, and up to 100%. An electrochemical cycle may include discharging the battery to an SOC of 100% or less, 95% or less, 90% or less, 75% or less, 50% or less, 25% or less, or 10% or less, and down to 0%. During a thermal cycle, the battery is exposed to conditions that include and elevated temperature for an exposure time. Sequential cycles may include different charging and discharging SOCs, different elevated temperature for the same and/or different exposure times or the same elevated temperature for the same and/or different exposure time. In some embodiments, an electrochemical cycle and thermal cycle may overlap in that the exposure to an elevated temperature may occur during use (during the electrochemical cycle).

According to an embodiment, the battery retains 50% or more (e.g., 50% to 100%), 80% or more (e.g., 80% to 100%), 90% or more (e.g., 90% to 100%), 95% or more (e.g., 95% to 100%), or 98% or more (e.g., 98% to 100%) of its capacity after exposure to a plurality of thermal cycles. According to an embodiment, the used current collector retains 50% or more (e.g., 50% to 100%), 80% or more (e.g., 80% to 100%), 90% or more (e.g., 90% to 100%), 95% or more (e.g., 95% to 100%), or 98% or more (e.g., 98% to 100%) of the mass of the unused current collector after exposure to a plurality of thermal cycles. According to an embodiment, the used current collector retains 50% or more (e.g., 50% to 100%), 80% or more (e.g., 80% to 100%), 90% or more (e.g., 90% to 100%), 95% or more (e.g., 95% to 100%), or 98% or more (e.g., 98% to 100%) of the thickness of the unused current collector after exposure to a plurality of thermal cycles. The change in thickness of a current collector may be measured, for example, by comparing x-ray images (e.g., computerized tomography scan images) of the unused current collector and its used counterpart. A thermal cycle exposes the battery to elevated temperature conditions. The elevated temperature conditions of a thermal cycle may include exposure to an elevated temperature of 100° C. or greater, 121° C. or greater, 135° C. or greater, or 140° C. or greater, and up to 200° C. (e.g., 100° C., 121° C., 135° C., 140° C., 100° C. to 200° C., 100° C. to 121° C., 100° C. to 135° C., or 135° C. to 200° C.) for a time period of 1 minute (min) or greater, 4 min or greater, 12 min or greater, 18 min or greater, 20 min or greater, 30 min or greater, 90 min or greater, 120 min or greater, or 180 min or greater, and up to 360 min (e.g., 1 min to 360 min, 4 min to 360 min, 4 min to 180 min, 12 min to 120 min, 12 min to 18 min, 18 min to 30 min, 18 min to 90 min, 18 min to 120 min, 18 min to 180 min, 20 min to 90 min, 20 min to 30 min, or 30 min to 90 min). In some embodiments, the plurality of thermal cycles is 4 or more, 5 or more, 10 or more, 50 or more, 100 or more, 200 or more, or 300 or more, and up to 500 thermal cycles (e.g., 5 to 500, 5 to 300, 5 to 200, 5 to 100, 50 to 200, 110 to 200, 100 to 300, or 100 to 500 thermal cycles).

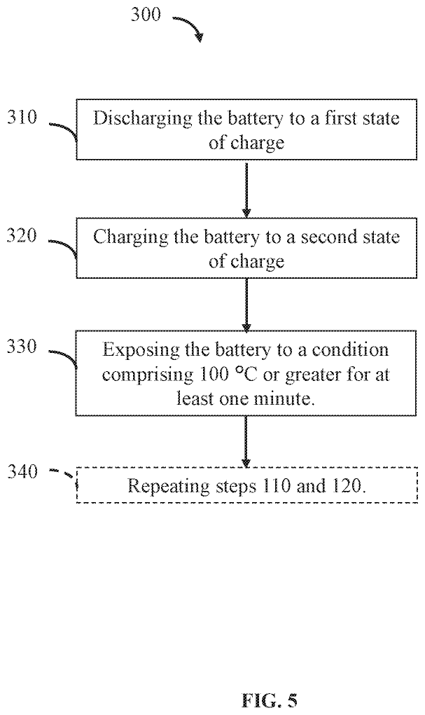

FIG. 5 is a flow diagram outlining a method of use of current collectors of the present disclosure. FIG. 5 includes a full cycle. The method 300 includes discharging the battery to which the current collector is included to a first SOC (step 310). Discharging the battery may be accomplished through the use of a piece of equipment or tool to which it is operable coupled. The battery may be discharged to any SOC (0% to 99%). In a full electrochemical cycle, the battery is discharge to a SOC of 0% to 5%.

The method 300 further includes charging the battery to second SOC (step 320). The battery may be charged to any SOC (e.g., 1% to 100%). In a full electrochemical cycle, the batter is charged to an SOC of 95% to 100%.

The method 300 further includes, exposing the battery to a condition that includes an elevated temperature of 100° C. or greater for at least 1 min. Completion of steps 310, 320, and 330 constitutes a single cycle (e.g., a full electrochemical cycle and a thermal cycle). In some embodiments, steps 310, 320, and 330 can be sequentially repeated for at least 5 cycles, at least 10 cycles, at least 50 cycles, at least 100 cycles, at least 200 cycles, at least 300 cycles, and up to 500 cycles.

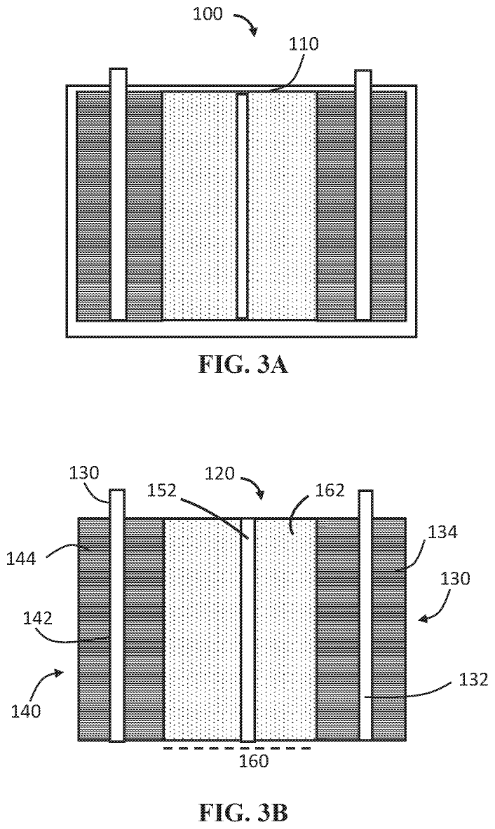

The present disclosure describes batteries that include a current collector of the present disclosure. FIG. 3A depicts the cross section of a cylindrical battery. Although not shown, the current collectors of the present disclosure may be used in a prismatic battery configuration, a button/coin battery configuration, and a pouch battery configuration. In some embodiments, the battery 1000 is a lithium ion battery.

The battery 1000 includes a housing 110. The housing 110 serves to contain the contents of the cell. Although not shown, in some embodiments, the housing 110 may be a conductive housing, that is, a housing at a non-neutral polarity. In such embodiments, the housing 110 is electrically conductive and may serve as an electrode or a current collector to complete the circuit of the battery. In some embodiments, the interior surface (the surface in contact with the electrode assembly), or a portion of the interior surface, of the housing may be coated with an insulative material. Coating at least a portion of the internal surface of the housing 110 with an insulative material may function to decrease and/or decrease the likelihood of housing corrosion and/or unwanted plating on the housing.

FIG. 3B is a cross-sectional view of the electrode assembly 120 of the battery 1000 of FIG. 3A. The electrode assembly 100 includes an anode 130, a cathode 140, a separator 150, and an electrolyte 160.

The electrode assembly 120 of the battery 100 includes a cathode 140. The cathode 140 is generally configured as the positive electrode. The cathode 140 includes a cathode current collector 142. The cathode current collector 142 may be of the current collectors (e.g., corrosion resistant current collectors) as described herein.

In some embodiments, the cathode 140 includes a cathode active material 38. The cathode active material 38 is the material that participates in the reduction reaction. In some embodiments the cathode active material includes a lithium-containing metal oxide, a lithium-containing metal phosphate, or both. Examples of lithium-containing metal oxides include lithium cobalt oxide (e.g., LiCoO₂), lithium magnesium oxide (e.g., LiMn₂O₄), lithium nickel manganese cobalt oxide (e.g., Li(NiMnCo)O₂), lithium nickel oxide (e.g., LiNiO₂), lithium nickel cobalt aluminum oxide (e.g., Li(NiCoAl)O₂), and combinations thereof. Examples of lithium-containing metal phosphates include lithium iron phosphate (e.g., LiFePO₄), lithium iron cobalt phosphate (LiFeₓCo₍₁₋ₓ₎PO₄; x=0.2, 0.5, 0.8, or 1), or both.

In some embodiments, at least a portion of the cathode active material 36 is surface treated. In some embodiments, the cathode active material surface treatment includes a metal oxide (e.g., Al₂O₃), a metal phosphate (e.g., LaPO₄), a metal halide, carbon, or a combination thereof. In some embodiments, the cathode active material surface treatment includes a positive temperature coefficient material. In some embodiments, the cathode active material is a lithium-containing metal oxide that is surface treated.

In some embodiments, the cathode 140 includes one or more additional cathode additives. In some such embodiments, the one or more cathode additives includes a positive temperature coefficient material.

In some embodiments, the cathode 140 includes a conductive carbon additive. The conductive carbon additive is electrically conductive and may serve to enhance the electrochemical performance of the cathode 140 and/or the cathode active material 38. Examples of conductive carbon additives include natural graphite, artificial graphite (e.g., mesocarbon microbead), graphene, carbon nanotubes, carbon black, and combinations thereof.

In some embodiments, the cathode 140 includes a cathode binder. The cathode binder allows for the physical connection and/or electrical connection of two or more parts of the cathode (e.g., cathode current collector, cathode active material, any cathode additives). Any suitable anode binder may be used. Examples of suitable cathode binders include carboxy methyl cellulose (CMC), styrene-butadiene rubber (SBR), polyvinylidene fluoride (PVDF), polytetrafluoroethylene (PTFE), or combinations thereof. In certain embodiments, the anode binder includes PVDF.

The anode 130 is generally configured as a negative electrode. The anode 130 includes an anode current collector 132. In some embodiments, the anode current collector 132 may be any current collector as described herein. In other embodiments, the anode current collector may be any suitable anode current collector material. Non-limiting examples of anode current collector materials include copper, aluminum, titanium, carbon, and combinations thereof. Although not depicted in FIG. 3A, in some embodiments the housing 110 is at least partially conductive and at a negative polarity, and serves as the anode current collector 132. The anode current collector 132 may be of any suitable configuration. Examples of suitable anode current collector configurations include a foil, a mesh, a foam, an etched surface, or combinations thereof. In some embodiments, the anode current collector is a copper foil.

In some embodiments, at least a portion of the anode current collector 132 is surface treated (e.g., coated). Non-limiting examples of surface treatments include carbon coatings; copper coatings; nitride coatings; oxide coatings that include copper, aluminum, titanium, carbon, or combinations thereof; or any combination thereof. In some embodiments, at least a portion of the anode current collector 132 is surface treated with a positive temperature coefficient material. A positive temperature coefficient material is a material that has an increase in electrical resistance when exposed to increased temperatures. In some embodiments, a positive temperature coefficient material includes a mixture of carbon black and a polymer (e.g., polypropylene).

The anode 130 includes an anode active material 134. The anode active material 134 is in electrical contact (directly and/or through a conductive material such as a conductive compound) with at least a portion of the anode current collector 132.

In some embodiments the anode active material 134 includes lithium. The lithium may be in the form of metallic lithium; a carbon-containing material capable of intercalating lithium such as graphite; a metal-alloy containing material capable of intercalating lithium such as lithium titanate (e.g., Li₄Ti₅O₁₂); lithium alloys such as lithium-aluminum, lithium-silicon, lithium-bismuth, lithium-cadmium, lithium-magnesium, lithium-tin, lithium-antimony, lithium-germanium, lithium-lead; oxides thereof; sulfides thereof; phosphides thereof; carbides thereof; nitrides thereof; and combinations thereof.

In some embodiments, the anode active material 134 includes a lithium titanium oxide. In some embodiments, the lithium titanium oxide includes a compound of the general formula Li₄MₓTi₅₋ₓO₁₂; where M is a metal selected from aluminum, magnesium, nickel, cobalt, iron, manganese, vanadium, copper, chromium, molybdenum, niobium, or combinations thereof; and 0≤x≤1. In some embodiments, the lithium titanium oxide includes Li₂Ti₃O₇; Li₄Ti_{4.75}V_{0.25}O₁₂; Li₄Ti_{4.75}Fe_{0.25}O_{11.88}; Li₄Ti_{4.5}Mn_{0.5}O₁; or combinations thereof. In some embodiments, the lithium titanium oxide includes a compound of the general formula LiM′M″XO₄; where M′ is a metal selected from nickel, cobalt, iron, manganese, vanadium, copper, chromium, molybdenum, niobium, or combinations thereof; M″ is a three valent non-transition metal; and X is a metal selected from zirconium, titanium, or a combination thereof.

In some embodiments, the lithium titanium oxide includes a lithium titanate. Lithium titanates are compounds consisting of lithium, titanium, and oxygen. In some embodiments, the lithium titanium oxide includes a lithium titanate of the general formula LiₓTi_{y}O₄; where x is 0≤x≤4; and y is 0≤y≤2. In some embodiments, the lithium titanate is used in any state of lithiation, for example, a compound of the general formula Li₄₊ₓTi₅O₁₂; where 0≤x≤3. In some embodiments the lithium titanate is Li₂TiO₃; Li₄Ti₅O₁₂ (also called Li₁₊ₓ[Li_{1/3}Ti_{5/3}]O₄ where 0≤x<1); Li₄TiO₄; or combinations thereof.

In some embodiments, the anode active material 134 includes a carbon-containing material capable of intercalating lithium. Examples of carbon-containing materials capable of intercalating lithium include natural graphite, artificial graphite (e.g., mesocarbon microbead), graphene, carbon nanotubes, carbon black, and combinations thereof.

In some embodiments, the anode active material includes a polymer.

In some embodiments, the anode active material 134 includes a metal-alloy containing material capable of intercalating lithium. Examples of metal-alloy containing materials capable of intercalating lithium include silicon-containing materials and tin-containing materials.

In some embodiments, the anode 130 includes one or more additional anode additives. In some such embodiments, the anode additive includes a positive temperature coefficient material.

In some embodiments, the anode 130 includes a conductive carbon additive. The conductive carbon additive does no intercalate lithium. The conductive carbon additive is electrically conductive. The conductive carbon additive may enhance the electrochemical performance of the anode 130 and/or the anode active material 134. Examples of conductive carbon additives include natural graphite, artificial graphite (e.g., mesocarbon microbead), graphene, carbon nanotubes, carbon black, and combinations thereof.

In some embodiments, the anode 130 includes an anode binder. The anode binder allows for the physical connection and/or electrical connection of one or more components (e.g., anode active material, anode current collector, anode additives) of the anode 130. Any suitable binder may be used such as those described relative to the cathode binder.

The electrode assembly 120 of the battery 100 includes a separator 152. The separator 152 is generally configured to inhibit direct interaction between the cathode 140 and the anode 130, thus limiting the likelihood of internal short circuits. The separator is also generally configured to allow for the transport of ions between the cathode 140 and the anode 130. The separator 152 is located in the interelectrode region 160. The interelectrode region 160 is the entire volume of the cell not occupied by the cathode 140 or the anode 130. The interelectrode region 160 includes any pores within the cathode 140 and/or the anode 130. Although not depicted, in some embodiments, the separator 152 may be in physical contact with one or both of the electrodes.

To allow for the transport of ions between the anode 130 and the cathode 140, the separator 152 is generally porous. At least some of the pores of the separator 152 are permeable, that is, they allow the ions to flow from one side of the separator 152 to the other side of the separator 152.

The separators included in the batteries of the present disclosure are designed to withstand multiple exposures to temperatures of greater than 100° C. with little to no degradation. Not wishing to be bound by theory, it is thought that the separator may not need to include a material that has a melting temperature equal to or greater than the highest temperature that the battery is intended to be exposed to. It is thought that although the battery is exposed to such temperatures, the separator within the battery may be at least partially insulated and as such, reach a lower temperature than the exposure temperature.

In some embodiments, the separator includes two or more layers. The two or more layers may or may not be bound together (e.g., laminated), to from a single multi-layer composite separator. Each layer of a composite separator may have the same melting temperature, each a layer of the composite separator may have different melting temperature, or two or more of the layers of the separator may have the same melting temperature while one or more other layers have different melting temperatures.

In some embodiments, the separator 152 includes one or more layers that have a melting temperature or mechanical degradation temperature of 100° C. or greater, preferably 125° C. or greater. In some embodiments, the separator includes one or more layers that have a melting temperature or mechanical degradation temperature of 100° C. or greater, 125° C. or greater, 135° C. or greater, 150° C. or greater, 160° C. or greater, 170° C. or greater, 180° C. or greater, or 200° C. or greater. There is no desired upper limit to the melting temperature or mechanical degradation temperature of a layer included in a separator; however, in practice the separator includes one or more layers having melting temperature or mechanical degradation temperature of 300° C. or less. In embodiments, the separator includes one or more materials having melting temperature or mechanical degradation temperature of 100° C. to 300° C., 125° C. to 300° C., 150° C. to 300° C., or 180° C. to 300° C.

In certain embodiments, multiple separator layers may be used, each of which has melting temperature or mechanical degradation temperature greater than 100° C. or greater than 125° C. In some embodiments, one or more of the layers of a composite separator may have a lower melting temperature or mechanical degradation temperature such that it melts or mechanically decomposes when exposed to an elevated temperature. Such a layer sandwiched between two or more layers that have melting temperature or mechanical degradation temperature above the elevated exposure temperature may serve the purpose of a shutdown separator. For example, a composite separator may include three layers. The inner layer may have a melting temperature or mechanical degradation temperature that is lower than the anticipated elevated temperature that the battery and/or separator will be exposed to. The two outer layers may have melting temperature or mechanical degradation temperature that are greater than the anticipated elevated temperature that the battery and/or separator will be exposed to. Upon exposure of the battery to an elevated temperature, the inner layer of the composite separator may melt or mechanically decompose, preventing ion flow in the battery while maintaining the separation between the anode and the cathode. An example of such a composite separator configuration includes a separator that has an inner layer material with a melting temperature or mechanical degradation temperature of approximately 130° C. and two outer layers having a melting temperature 200° C. or greater. Such separators may include a polyethylene inner layer and polypropylene outer layers such as the separators available from CELGARD (Charlotte, NC) under the trade name CELGARD TRILAYER PP/PE/PP.

The separator 152 may include any suitable separator material. Examples of suitable separator materials include, polymeric porous membranes such as polyethylene, polypropylene, polyterephthalate, polyimide, cellulose based polymers and combinations thereof; ceramic coated polymeric porous membranes (e.g., ceramic coated polypropylene, ceramic coated polyethylene, or both); modified polymeric membranes with thin oxide coatings of titania (TiO₂), zinc oxide (ZnO), silica (SiO₂), and combinations thereof; and hybrid organic-organic assemblies such as those that contain SiO₂ nanoparticles covalently tethered within a polymeric network such as polyurethanes, polyacrylates, polyethylene glycol; and combinations thereof.

In some embodiments, the separator material is a material that has a melting temperature mechanical degradation temperature of 125° C. or greater. Examples of such materials include polyimides, polyolefins (e.g., polypropylene), polyethylene terephthalate, ceramic-coated polyolefin, cellulose, or combinations thereof. Such materials may be in the form in microfibers, nanofibers, or both. In some embodiments, the separator includes a combination of microfibers and nanofibers. In some embodiments, the separator includes polyethylene terephthalate microfibers and cellulose nanofibers. Examples of such separators are disclosed in U.S. Pat. No. 8,936,878 and are available from Dreamweaver International (in Greer, SC) under the tradename SILVER, GOLD, and TITANIUM.

Examples of separator materials that have a melting temperature of 200° C. or greater include polyimide, polyethylene terephthalate, cellulose, aramid fibers, ceramics, and combinations thereof.

In some embodiments, the separator may be surface treated. In some embodiments, one or more layers of a composite separator may be surface treated. Example surface treatments include carminic treatments such as aluminum oxides and silicon oxides (SiOX).

The electrode assembly 120 of the battery 100 includes an electrolyte 162. The electrolyte 162 may occupy any or all of the interelectrode region 160. The electrolyte 162 physically contacts the anode 130, the cathode 140, and the separator 152. The electrolyte is a homogenous solution that includes at least one salt and a solvent.

In some embodiments, the electrolyte includes one or more additional salts. In some embodiments, the one or more additional salts are employed at concentrations below their respective saturation points at the application temperature. As such, the salts are dissolved into their component ions and are a part of the electrolyte. In a lithium-ion battery, at least one of the salts includes lithium.

In some embodiments, the electrolyte includes at least one halogen containing salt. In such embodiments, the halogen containing salt may contribute to the formation of the one or more passivation regions as discussed elsewhere herein. In some embodiments, the electrolyte may include a halogen containing salt, a lithium and halogen containing salt, a lithium salt that does not include a halogen, or combinations thereof. In some embodiments the halogen containing salt a fluorine containing salt. In some embodiments the halogen containing salt a chlorine containing salt. In some embodiments, the fluorine contain salt also includes lithium. In some embodiments, the halogen containing salt does not include lithium.

Examples of fluorine and lithium containing salts include lithium bis(trifluoromethanesulfonimide) (LiTFSI); lithium difluoro (oxalato)borate (LiDFOB); lithium bis(pentafluoroethyl sulfonyl)imide (LiBETI); lithium bis(fluorosulfonyl)imide (LiFSI), lithium difluoro (oxalate)borate (LiDFOB); lithium tetrafluoroborate (LiBF₄); bis(perfluoroethanesulfonyl)imide (LiPFSI or LiBETI); lithium-cyclo-difluoromethane-1,1-bis(sulfonyl)imide (LiDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dicyano-pentafluoroethyl-imidazole; and combinations thereof.

Examples of chlorine and lithium containing salts include lithium perchlorate.

Examples of lithium salts that do not include a halogen include lithium bis(oxalate)borate (LiBOB); lithium tetracyanoborates (Bison); lithium dicyanotriazlate (DCTA).

The battery has a total amount of salt. The total amount of salt is the sum of the sum of all salts included in the electrolyte. The molar quantity of the total amount salt is based on the volume of the electrolyte. In some embodiments, the electrolyte has a total amount of salt that is 0.01 M or greater, 0.5 M or greater, 1 M or greater, 2 M or greater, 3 M or greater, 4 M or greater, or 5 M or greater. In some embodiments, the electrolyte has a total amount of salt that is 6 M or less, 5 M or less, 3 M or less, 2 M or less, 1 M or les, or 0.5 M or less. In some embodiments, the electrolyte has a total amount of salts that is 0.01 M to 6 M, 0.01 M to 5 M, 0.01 M to 4 M, 0.01 M to 3 M, 0.01 M to 2 M, 0.01 M to 1 M, or 0.01 M to 0.5 M. In some embodiments, the electrolyte has a total amount of salt that is 0.5 M to 6 M, 0.5 M to 5 M, 0.5 M to 4 M, 0.5 M to 3 M, 0.5 M to 2 M, or 0.5 M to 1 M. In some embodiments, the electrolyte has a total amount of salt that is 1 M to 6 M, 1 M to 5 M, 1 M to 4 M, 1 M to 3 M, or 1 M to 2 M. In some embodiments, the electrolyte has a total amount of salt that is 2 M to 6 M, 2 M to 5 M, 2 M to 4 M, or 2 M to 3 M. In some embodiments, the electrolyte has a total amount of salt that is 3 M to 6 M, 3 M to 5 M, or 3 M to 4 M. In some embodiments, the electrolyte has a total amount of salt that is 4 M to 6 M or 4 M to 5 M. In some embodiments, the electrolyte has a total amount of salt that is 5 M to 6 M.

Generally, the use of LiPF₆ alone in an electrolyte may result in rapid mechanical and/or electrochemical degradation of the battery when exposed to elevated temperatures. In some embodiments, the battery includes 25 mol-% or less of LiPF₆ of the total salt amount, if any. In some embodiments, the battery has a total salt amount that includes 25 mol-% or less, 15 mol-% or less, 10 mol-% or less, 5 mol-% or less, 1 mol-% or less, if any, of LiPF₆. In some embodiments, the battery has a total salt amount that includes 1 mol-% to 5 mol-%, 1 mol-% to 10 mol-%, 1 mol-% to 15 mol-%, 1 mol-% to 25 mol-%, 5 mol-% to 10 mol-%, or 5 mol-% to 15 mol-% of LiPF₆, if any.

In some embodiments, the electrolyte 162 is a liquid electrolyte. A liquid electrolyte includes a solvent and at least one salt. In some embodiments the solvent is an organic solvent. Examples of suitable organic solvents include linear carbonates such as ethylmethyl carbonate (EMC), ethylene carbonate (EC), dimethyl carbonate (DMC), diethyl carbonate (DEC); ethers such as 1,2,-diethoxyethane (DME); linear carboxylic esters such as methyl formate, methyl acetate, and methyl propionate; nitriles such as acetonitrile; cyclic carbonates such as butylene carbonate (BuC), phenylene carbonate (PeC), hexylene carbonate (HeC), octylene carbonate (OcC), and dodecylene carbonate (DoC); organo sulfur compounds such as sulfolane; and combinations thereof.

Organic solvents that have high boiling points tend to have increased viscosities which may result in lower ionic conductivity. As such, in some embodiments, the organic solvent of the electrolyte includes at least one solvent having a boiling point below 140° C. Examples of such solvents include some linear carbonates such as 1,2-diethyoxyethane; some linear carboxylic esters such as methyl formate, methyl acetate, ethyl acetate, and methyl propionate; and some nitriles such as acetonitrile.

In certain embodiments, the organic solvent includes a mixture of ethylene carbonate (EC) and ethylmethyl carbonate (EMC). In certain embodiments, the organic solvent includes a mixture EC and EMC in a range of 10:90 to 50:50 by weight. In certain embodiments, the organic solvent includes a mixture of EC and EMC in a weight ratio of 30:70.

In certain embodiments, the organic solvent includes a mixture of EC, EMC, and sulfolane (SL). In certain embodiments, the organic solvent includes a mixture of EC, EMC and SL in a weight ratio of 20:10:70.

In some embodiments, the electrolyte includes one or more electrolyte additives. Typically, an electrolyte additive enables a higher voltage operation (e.g., greater than 4.2 V), but can also be used at lower voltages (e.g., less than 4.2 V) and at elevated temperatures (e.g., temperatures greater than 100° C.). The electrolyte additives may include unsaturated compounds such as vinylene carbonate (VC) or vinyl ethylene carbonate (VEC); a sulfur-containing compound such as 1,3-propane sultone (PS), prop-e-ene 1,3-sultone (PES), 1,3,2-dioxthiolane-2-2dioxide (DTD), trimethylene sulfate (TMS), methylene methyl disulfonate (MMDS); boron-containing compounds such as trimethylboroxine and trimethoxyboroxine (TMOBX); phosphorous-containing compounds such as tris(1,1,1,3,3,3-hexafluoro-2-isopropyl)phosphate (HFiP), tris(trimethylsilyl)phosphate (TTSP), tris(trimethylsilyl)phosphite (TTSPi), triallyl phosphate (TAP); aromatic compounds such as biphenyl (BP); heterocyclic compounds such as thiophene (TP); Lewis acid-base adducts such as pyridine-boron trifluoride (PBF); 2,4,6,8-tetramethyl-2,4,6,8-tetravinylcyclotetra-siloxane (ViD4); and mixtures thereof.

In some embodiments, the electrolyte 162 is a gel electrolyte. A gel electrolyte includes a polymer network that immobilizes a liquid electrolyte containing a solvent and one or more salts where one of the one or more salts is LiBOB. The solvent may be any organic solvent described elsewhere herein. The one or more salts may be any salt or combination of salts described elsewhere herein. The polymer network may include one or more polymers. Examples of suitable polymers include poly(ethylene oxide) and copolymers such as poly(ethylene-propylene oxide); polymers based on the acrylic group such as poly(methyl methacrylate), poly(acrylic acid), lithium poly(acrylate), poly(ethylene glycol diacrylate), and combinations thereof; polymers based on the vinylidene fluoride group such as poly(vinylidene fluoride) (PVdF), copolymers such as poly(vinylidene fluoride-hexafluoropropylene) (PVdF-HFP), and combinations thereof; and combinations thereof.

In some embodiments, when employed in a battery that is subjected to elevated temperatures, at least one current collector is corrosion resistant. In some embodiments, the at least one corrosion resistant current collector is the current collector as described herein. The current collector may display any level of corrosion, or lack thereof, after exposure to a given set of conditions as described elsewhere herein.

In some embodiments, the batteries of the current collect maintain at least a portion of their capacity after exposure to a given set of conditions. The amount of retention of capacity may be any amount after exposure to a given set of conditions as described elsewhere herein.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

### EXAMPLES

Lithium ion cells of 100 mAh nominal capacity were constructed as spirally wound prismatic cells in a stainless steel enclosure that was hermetically sealed and used a glass feedthrough. The positive electrodes included LiCoO₂ active material for cell groups 1A and 1B and LiNiCoAlO₂ active material for cells 2A and 2B. The active materials were coated onto a bare aluminum current collector for cell groups 1A and 2A and onto a carbon-coated aluminum current collector for cell groups 1B and 2B. The negative electrodes included artificial graphite negative active material coated onto a copper current collector. The positive and negative electrodes were prepared using a slurry coating and calendering process. Both electrodes included their respective active materials, a conductive carbon diluent, and a polymeric polyvinylidene difluoride binder. The cells were filled with 1.5±0.1 g of electrolyte, the composition of which is described in Table 1 for each cell group. The separator was a 25 μm nanofiber membrane with a melt integrity of 300° C., sold under the tradename of Dreamweaver SILVER25 (available from Dreamweaver International in Greer, SC).

Within 24 hours of filling cells of cell group 1A and 1B with electrolyte and sealing the cells, the cells were put through a formation protocol, described by:
1. Constant current (CC) charge at a rate of 0.1 C (current of 10 mA) to an upper cutoff voltage of 4.1 V
2. Constant voltage (CV) hold at 4.1 V for 4 hours
3. Open circuit storage for 30 hours
4. CC discharge at a rate of 0.1 C (current of 10 mA) to a lower cutoff voltage of 3.575 V
5. Open circuit storage for 10 minutes
6. CC charge at a rate of 0.1 C (current of 10 mA) to an upper cutoff voltage of 4.1 V
7. CV hold at 4.1 V for 1 hour
8. Open circuit storage for a minimum of 1 hour

Once the formation protocol was complete, the cells of cell group 1A and 1B proceeded through an initial electrochemical performance test, described by:
1. 12 CC-CV charge-CC discharge cycles of 0.5C (50 mA) CC charge to 4.1 V with a CV hold at 4.1 V until the current was less than or equal to 4.2 mA, and 0.5 C (50 mA) CC discharge to 3.575 V
2. 1 CC-CV charge-CC discharge cycle of 0.1 C (10 mA) CC charge to 4.1 V with a CV hold at 4.1 V until the current was less than or equal to 4.2 mA, and 0.1 C (10 mA) CC discharge to 3.575 V
3. CC-CV charge at a rate of 0.1 C (10 mA) to 3.8 V with a CV hold at 4.1 V until the current was less than or equal to 4.2 mA

Following the initial electrochemical performance test described above, the 1 kHz AC impedance and center thickness were measured at 20° C. for all cells of cell group 1A and 1B and then the cells in each cell group were divided into two subgroups: one control group and one exposed group. The control group remained at room temperature while the exposed group cells were placed into a convection oven at a temperature of 135° C. for two hours. Following the 135° C. exposure, the cells were allowed to cool to room temperature, then both the control and exposed group cells proceeded through a final electrochemical performance test, described by:
1. 14 CC-CV charge-CC discharge cycles of 0.5 C (50 mA) CC charge to 4.1 V with a CV hold at 4.1 V until the current was less than or equal to 4.2 mA, and 0.5C (50 mA) CC discharge to 3.575 V
2. 1 CC-CV charge-CC discharge cycle of 0.1 C (10 mA) CC charge to 4.1 V with a CV hold at 4.1 V until the current was less than or equal to 4.2 mA, and 0.1C (10 mA) CC discharge to 3.575 V
3. CC-CV charge at a rate of 0.1 C (10 mA) to 3.8 V with a CV hold at 4.1 V until the current was less than or equal to 4.2 mA

Following the final electrochemical performance test described above, the 1 kHz AC impedance and center thickness were measured at 20° C. for the control and exposed subgroups.

Within 24 hours of filling the cells with electrolyte and sealing the cells, the cell of cell group 2A and 2B were put through a formation protocol at an application temperature of 25° C.±1° C., described by:
1. Constant current (CC) charge at a rate of 0.1 C (current of 10 mA) to an upper cutoff voltage of 4.1 V
2. Constant voltage (CV) hold at 4.1 V for 4 hours
3. Open circuit storage for 30 hours
4. CC discharge at a rate of 0.1 C (current of 10 mA) to a lower cutoff voltage of 2.8 V
5. Open circuit storage for 10 minutes
6. CC charge at a rate of 0.1 C (current of 10 mA) to an upper cutoff voltage of 4.1 V
7. CV hold at 4.1 V for 1 hour
8. Open circuit storage for a minimum of 1 hour

Once the formation protocol was complete, the cells of cell group 2A and 2B proceeded through an electrochemical performance test at an application temperature of 25° C.±1° C., described by:
1. 5 CC-CV charge-CC discharge cycles of 0.5 C (50 mA) CC charge to 4.1 V with a CV hold at 4.1 V until the current was less than or equal to 10 mA, and 0.5° C. (50 mA) CC discharge to 2.8 V
2. 1 CC-CV charge-CC discharge cycles of 0.1 C (10 mA) CC charge to 4.1 V with a CV hold at 4.1 V until the current was less than or equal to 5 mA, and 0.1 C (10 mA) CC discharge to 2.8 V
3. 1 CC-CV charge-CC+DCIR pulse cycles of 0.1 C (10 mA) CC charge to 4.1 V with a CV hold at 4.1 V until the current was less than or equal to 5 mA, and 0.1 C (10 mA) CC background current draw with 5 second 2 W pulses done at 4.1 V, 3.7 V, and 3.5 V.
4. 1 CC charge at 0.5 C (50 mA) to 4.1 V with a CV hold at 4.1 V until the current was less than or equal to 10 mA.

Following the electrochemical performance test described above, the cells of cell group 2A and 2B were divided into two subgroups: one control group and one exposed group. All cells were at 100% state of charge. The control group remained at room temperature while the exposed group cells were placed in a benchtop steam autoclave (Tuttnauer EZ9) with a sterilization dwell setting of 135° C. for 18 minutes. A linear ramp and dry profile was used with an approximate 20 minute ramp time. Following the autoclave sterilization cycle, both the control and the exposed cells were discharged to 2.8 V at 0.5 C (50 mA) and then proceeded through the same electrochemical performance test at application temperature described above. This was repeated four more times for a total of five autoclave exposures for a cumulative dwell time of 90 minutes at 135° C.

Table 1 tabulates the % of capacity retention at a C/2 (0.5 C) rate, the % change in the measured cell thickness, and the % change in the 1 kHz AC impedance resulting from 90-120 minutes of 135° C. temperature exposure. In comparing cell group 1A to 1B and cell group 2A to 2B, the impact of the corrosion-protection on the aluminum positive current collector is evident. For the LCO/Graphite chemistry (cell group 1A and 1B), the use of carbon-coated Al current collector resulted in a significant increase in retained capacity, a reduction in cell swelling, and reduction in AC impedance, consistent with a reduction in Al corrosion. For the NCA/Graphite chemistry (cell group 2A and 2B), again the use of a carbon-coated Al current collector resulted in an increase in retained capacity, a reduction in cell swelling, and reduction in AC impedance, consistent with a reduction in Al corrosion. The LiDFOB salt present in the cell group 2A and 2B cells is known to partially passivate the Al surface, while the LiTFSI salt in cell group 1A and 1B cells is known to not passivate the Al surface. This is consistent with the more significant impact of use of the corrosion-resistant current collector for cell group 1B cells compared to cell group 1A cells as opposed to cell group 2B cells compared to cell group 2A cells.

TABLE 1

| | | | | % C/2 | % change | % change |
|---|---|---|---|---|---|---|
| | Cell | Current | | capacity | in | in |
| Cell | Chemistry | Collector | Electrolyte | retention | thickness | impedance |
| 1A | LCO// | Al | 0.9M LiTFSI + | 16.3 | 10.8 | 42.2 |
| | Graphite | | 0.2M LiBOB in | | | |
| | | | EC:EMC | | | |
| 1B | LCO// | c-Al | 0.9M LiTFSI + | 98.9 | 5.5 | 16.4 |
| | Graphite | | 0.2M LiBOB in | | | |
| | | | EC:EMC | | | |
| 2A | NCA// | Al | 0.9M LiDFOB + | 51.5 | 15.6 | 328 |
| | Graphite | | 0.2M LiBOB in | | | |
| | | | EC:E constructed | | | |
| | | | MC | | | |
| 2B | NCA// | c-Al | 0.9M LiDFOB + | 77.5 | 16.8 | 125 |
| | Graphite | | 0.2M LiBOB in | | | |
| | | | EC:EMC | | | |

The following examples are a non-limiting list of clauses in accordance with one or more techniques of this disclosure.

Example 1. A current collector for a lithium ion battery, the current collector comprising: a bulk material defining a surface, the bulk material comprising: a base metal doped with 0.01 wt-% to 49.9 wt-% of a metal dopant comprising magnesium; and a passivating region comprising magnesium-halide passivating groups comprising at least a portion of the metal dopant; the passivating region forming at least a portion of the surface.

Example 2. The current collector of Example 1, wherein the base metal is aluminum.

Example 3. The current collector of Example 1 or 2, wherein the bulk material is in a foil configuration.

Example 4. The current collector of any one of Examples 1 through 3, wherein the base metal is doped with 0.1 wt-% to 5 wt-% magnesium.

Example 5. The current collector of any one of Examples 1 through 4, wherein the magnesium-halide passivating groups comprise fluorine.

Example 6. The current collector of Example 5, wherein the magnesium-halide passivating group is MgF₂.

Example 7. The current collector of any one of Examples 1 through 6, wherein the passivation region further comprises magnesium oxide passivation groups, base-oxide passivation groups, or both.

Example 8. The current collector of any one of Examples 1 through 7, wherein the passivation region is a passivation layer, the passivation layer forming an entire surface.

Example 9. The current collector of any one of Examples 1 through 8, wherein the base material comprises a gradient of magnesium wherein the surface comprises a higher concentration of magnesium than an interior of the current collector.

Example 10. The current collector of any one of Examples 1 through 9, wherein the current collector is configured to operate at 3.6 V or higher.

Example 11. The current collector of any one of Examples 1 through 10, wherein the current collector when disposed within a battery has an unused thickness and an unused mass, and wherein after exposure to conditions comprising a temperature of 100° C. or greater for 4 min or greater, the current collector is a used current collector, and wherein the used current collector retains at least 50% of the unused mass, the used current collector retains at least 50% of the unused thickness, the battery retains at least 50% of its capacity compared to the same battery prior to exposure to the conditions, or combinations thereof.

Example 12. The current collector of any one of Examples 1 through 10, wherein the current collector when disposed within a battery has an unused thickness and an unused mass, and wherein after at least one cycle comprising exposure to conditions comprising a temperature of 100° C. or greater for 4 min or greater, the current collector is a used current collector, and wherein the used current collector retains at least 50% of the unused mass, the used current collector retains at least 50% of the unused thickness, the battery retains at least 50% of its capacity compared to the same battery prior to exposure to the conditions, or combinations thereof.

Example 13. The current collector of claim 11 or 12, wherein the used current collector retains at least 90% of the unused mass, the used current collector retains at least 90% of unused thickness, the battery retains at least 90% of its capacity compared to the same battery prior to exposure to the conditions, or combinations thereof.

Example 14. A lithium-ion battery comprising: a housing; an electrode assembly comprising: a positive electrode; and a negative electrode; at least one of the positive electrode or the negative electrode comprising the current collector of any one of claims 1 through 13; a separator; and an electrolyte.

Example 15. The lithium-ion battery of Example 12, wherein the electrolyte comprises a halogen containing salt, wherein the halogen is fluorine or chlorine.

Example 16. The lithium-ion battery of Example 13, wherein the halogen containing salt comprises lithium bis(trifluoromethanesulfonimide) (LiTFSI); lithium difluoro (oxalato)borate (LiDFOB); lithium bis(pentafluoroethyl sulfonyl)imide (LiBETI); lithium bis(fluorosulfonyl)imide (LiFSI), lithium difluoro (oxalate)borate (LiDFOB); lithium tetrafluoroborate (LiBF₄); bis(perfluoroethanesulfonyl)imide (LiPFSI or LiBETI); lithium-cyclo-difluoromethane-1,1-bis(sulfonyl)imide (LiDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dicyano-pentafluoroethyl-imidazole; or combinations thereof.

Example 17. The lithium-ion battery of any one of Examples 12 through 16, wherein the electrolyte comprises LiPF₆ in an amount of no greater than 25 mol-%.

Example 18. A method of making the current collector of any one of Examples 1 through 13 comprising: contacting the bulk material with a passivation mixture.

Example 19. The method of Example 18, further comprising exposing the bulk material to a migration temperature to form a metal dopant gradient within the baes metal.

Example 20. The method of Example 18 or 19, further comprising exposing the bulk material to a passivation temperature while the bulk material is in contact with the passivation mixture.

Example 21. The method of any one of Examples 18 through 20, the method further comprising forming a battery comprising the current collector and the passivation mixture and allowing the passivation region to form in situ within the battery.

Example 22. The method of any one of Examples 18 through 21, wherein the passivation mixture includes a halogen, a halogen containing salt, or both.

Example 23. A method of using the battery of anyone of Examples 15 through 22 comprising: i) discharging the battery; ii) charging the battery; iii) exposing the battery to a condition comprising 100° C. or greater for at least one minute.

Example 24. The method of Example 23, further comprising repeating steps i, ii, and iii 2 to 500 times.

1. A current collector for a lithium ion battery for an autoclavable device, the current collector comprising:
a bulk material defining a surface, the bulk material comprising:
a base metal doped with 0.01 wt-% to 49.9 wt-% of a metal dopant comprising magnesium; and
a passivating region comprising magnesium-halide passivating groups comprising at least a portion of the metal dopant; the passivating region forming at least a portion of the surface.

2. The current collector of claim 1, wherein the base metal comprises aluminum.

3. The current collector of claim 1, wherein the bulk material is in a foil configuration.

4. The current collector of claim 1, wherein the magnesium-halide passivating groups comprise fluorine.

5. The current collector of claim 1, wherein the passivation region further comprises at least one of magnesium oxide passivation groups or base-oxide passivation groups.

6. The current collector of claim 1, wherein the bulk material comprises a gradient of magnesium wherein the surface comprises a higher concentration of magnesium than an interior of the current collector.

7. The current collector of claim 1, wherein the current collector is configured to operate at 3.6 V or higher.

8. The current collector of claim 1, wherein the current collector when disposed within a battery has an unused thickness and an unused mass, and wherein after exposure to conditions comprising a temperature of 100° C. or greater for 4 min or greater, the current collector is a used current collector, and wherein the used current collector retains at least 50% of the unused mass, the used current collector retains at least 50% of the unused thickness, the battery retains at least 50% of its capacity compared to the same battery prior to exposure to the conditions, or combinations thereof.

9. The current collector of claim 8, wherein the used current collector retains at least 90% of the unused mass, the used current collector retains at least 90% of unused thickness, the battery retains at least 90% of its capacity compared to the same battery prior to exposure to the conditions, or combinations thereof.

10-15. (canceled)

16. The current collector of claim 4, wherein the magnesium-halide passivating group comprises MgF₂.

17. The current collector of claim 1, wherein the base metal comprises aluminum doped with 0.1 wt-% to 5 wt-% magnesium.

18. The current collector of claim 1, wherein the passivation region is a passivation layer forming an entire surface.

19. An autoclavable medical device comprising:
a lithium-ion battery comprising:
a housing;
an electrode assembly comprising:
a positive electrode; and
a negative electrode;
a separator; and
an electrolyte;
wherein at least one of the positive electrode or the negative electrode comprises a current collector comprising:
a bulk material defining a surface, the bulk material comprising:
a base metal doped with 0.01 wt-% to 49.9 wt-% of a metal dopant comprising magnesium; and
a passivating region comprising magnesium-halide passivating groups comprising at least a portion of the metal dopant; the passivating region forming at least a portion of the surface.

20. The autoclavable medical device of claim 19, wherein the electrolyte comprises a halogen containing salt, wherein the halogen is fluorine or chlorine.

21. The autoclavable medical device of claim 20, wherein the halogen containing salt comprises lithium bis(trifluoromethanesulfonimide) (LiTFSI); lithium difluoro (oxalato)borate (LiDFOB); lithium bis(pentafluoroethyl sulfonyl)imide (LiBETI); lithium bis(fluorosulfonyl)imide (LiFSI), lithium difluoro (oxalate)borate (LiDFOB); lithium tetrafluoroborate (LiBF₄); bis(perfluoroethanesulfonyl)imide (LiPFSI or LiBETI); lithium-cyclo-difluoromethane-1,1-bis(sulfonyl)imide (LiDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dicyano-pentafluoroethyl-imidazole; or combinations thereof.

22. The autoclavable medical device of claim 19, wherein the electrolyte comprises LiPF₆ in an amount of no greater than 25 mol-%.

23. A method of making a current collector for a lithium ion battery for an autoclavable device, the method comprising:
providing a bulk material comprising a base metal doped with 0.01 wt-% to 49.9 wt-% of a metal dopant comprising magnesium; and
contacting a bulk material a passivation mixture comprising a halogen, a halogen containing salt, or both to form a passivating region on a surface of the bulk material, wherein the passivating region comprises magnesium-halide passivating groups comprising at least a portion of the metal dopant, and wherein the passivating region forms at least a portion of a surface of the current collector.

24. The method of claim 23, further comprising at least one of:
exposing the bulk material to a migration temperature to form a metal dopant gradient within the baes metal; or
exposing the bulk material to a passivation temperature while the bulk material is in contact with the passivation mixture.

25. The method of claim 23, further comprising forming a battery comprising the current collector and the passivation mixture and allowing the passivation region to form in situ within the battery.

26. The method of claim 26, further comprising:
installing the battery in an autoclavable device, and
exposing the an autoclavable device containing the battery to a condition comprising 100° C. or greater for at least one minute.
